(19) United States
(12) Patent Application Publication
(10) Pub. No.: US 2014/0173910 A1
(43) Pub. Date: Jun. 26, 2014

(54) FOLDING TOOL ASSEMBLY

(71) Applicant: Kai U.S.A., Ltd., Tualatin, OR (US)

(72) Inventors: Craig Donald Kemp Green, Newberg, OR (US); James MacNair, Newberg, OR (US)

(73) Assignee: Kai U.S.A., Ltd., Tualatin, OR (US)

(21) Appl. No.: 14/137,776

(22) Filed: Dec. 20, 2013

Related U.S. Application Data
(60) Provisional application No. 61/745,351, filed on Dec. 21, 2012.

(51) Int. Cl. B26B 11/00; B25F 1/04; B26B 1/04

(52) U.S. Cl. CPC B26B 11/00; B26B 1/044; B25F 1/04
USPC 30/161; 81/490

(57) ABSTRACT

A folding knife includes a handle assembly, a blade, and a secondary tool. The blade is pivotally connected to the handle assembly and is configured to pivot from a closed position to an opened position. The secondary tool is pivotally connected to the handle assembly and is configured to pivot from a closed position to an opened position. The secondary tool includes a locking member that traps the blade in the closed position when the secondary tool is in the opened position but allows the blade to pivot to the opened position when the secondary tool is in the closed position.

### CROSS REFERENCE TO RELATED APPLICATIONS

This application claims priority to U.S. Provisional Patent Application No. 61/745,351, entitled FOLDING TOOL ASSEMBLY, filed Dec. 21, 2012, the entirety of which is hereby incorporated herein by reference.

### BACKGROUND

Knives and/or other tools can be combined together in folding tools. Various tools can be selected for inclusion on a given folding tool based on the desired functionality of the folding tool. In general, it is desirable to increase the utility of the folding tool while also increasing the safety of the folding tool.

### SUMMARY

A folding knife includes a handle assembly, a blade, and a secondary tool. The blade is pivotally connected to the handle assembly and is configured to pivot from a closed position to an opened position. The secondary tool is pivotally connected to the handle assembly and is configured to pivot from a closed position to an opened position. The secondary tool includes a locking member that traps the blade in the closed position when the secondary tool is in the opened position but allows the blade to pivot to the opened position when the secondary tool is in the closed position.

### BRIEF DESCRIPTION OF THE DRAWINGS

FIG. 1A shows an example folding tool assembly with both a primary tool and a secondary tool in an opened position.

FIG. 1B shows the folding tool assembly of FIG. 1A with the secondary tool in a closed position.

FIG. 2 shows an exploded view of the folding tool assembly of FIGS. 1A and 1B.

FIG. 3A shows a partial view of the folding tool assembly of FIG. 1 with both a primary tool and a secondary tool in a closed position.

FIG. 3B shows the partial view of FIG. 3A with the secondary tool pivoting from the closed position to an opened position.

FIG. 3C shows the partial view of FIGS. 3A and 3B with the secondary tool in an opened position.

FIG. 4A shows the folding tool assembly of FIGS. 1A and 1B with both a primary tool and a secondary tool in a closed position.

FIG. 4B is shows the folding tool assembly of FIG. 4A with the secondary tool in an opened position.

### DETAILED DESCRIPTION

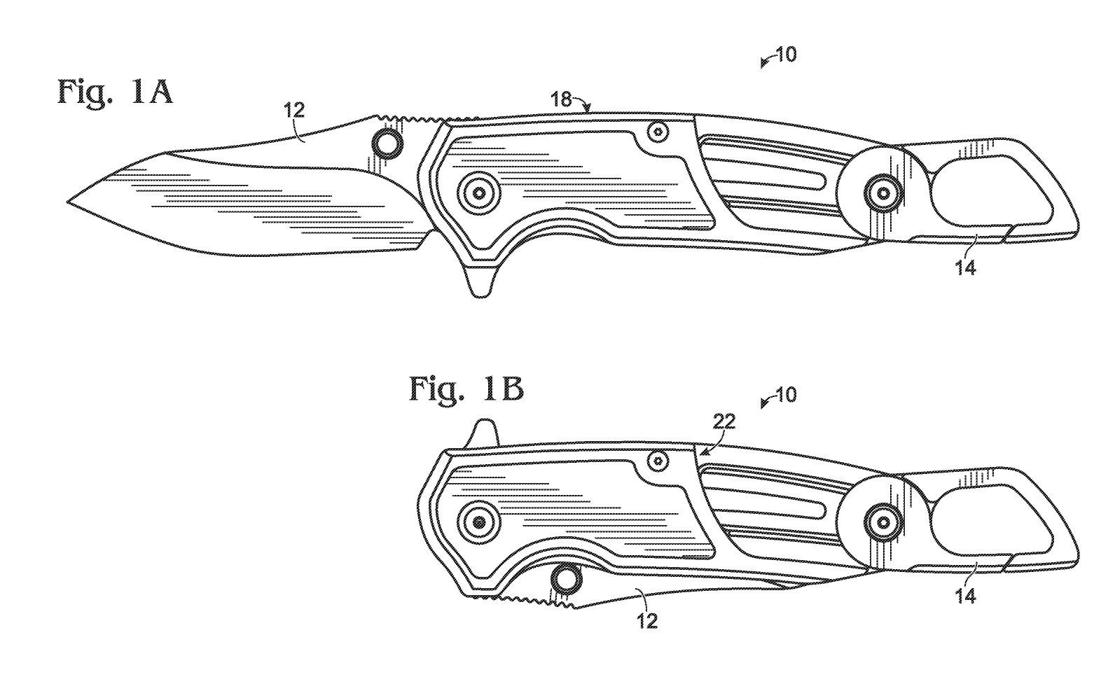

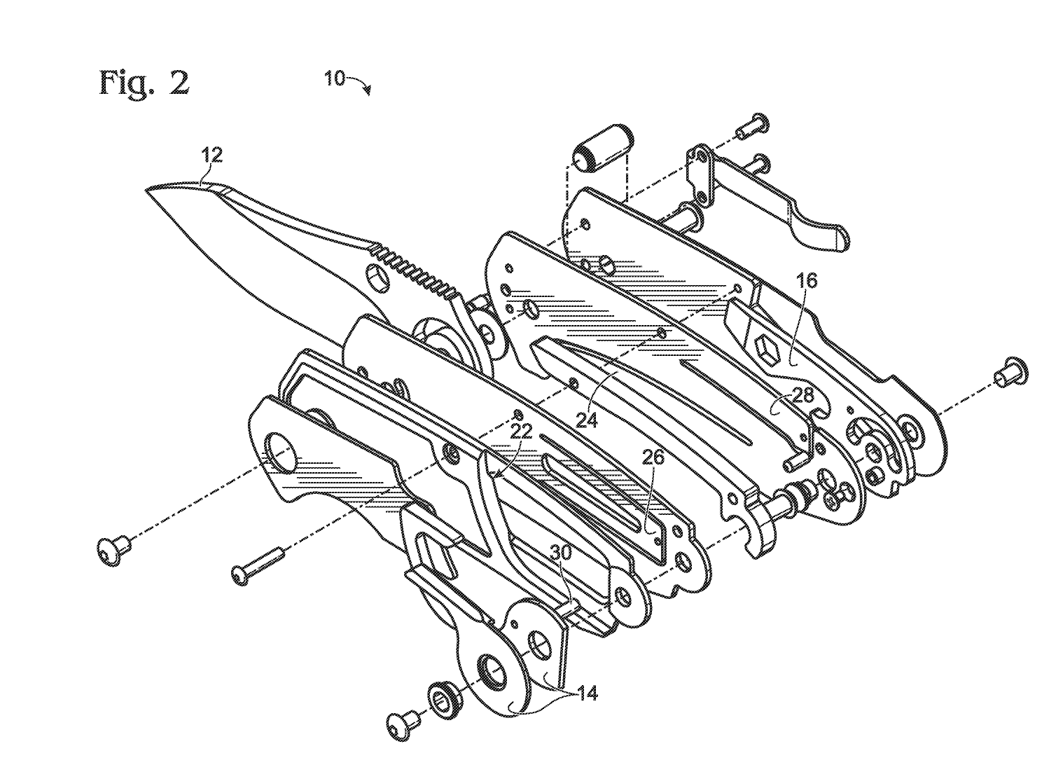

FIGS. 1-4B show a nonlimiting example of a folding tool assembly 10 in accordance with an embodiment of the present disclosure. In the illustrated example, the folding tool assembly includes a primary tool in the form of a blade 12, a secondary tool in the form of a carabineer 14, and a tertiary tool in the form of a multi-tool 16 with screwdriver, wrench, and opener functionality. However, it should be understood that these example tools are nonlimiting. Folding tool assemblies in accordance with the present disclosure may include more, fewer, and/or different tools.

The folding tool assembly includes a handle assembly 18 to which each of the primary, secondary, and tertiary tools is pivotably connected. Each of the pivoting tools is configured to pivot from a closed position to an opened position, and vice versa, relative to the handle assembly.

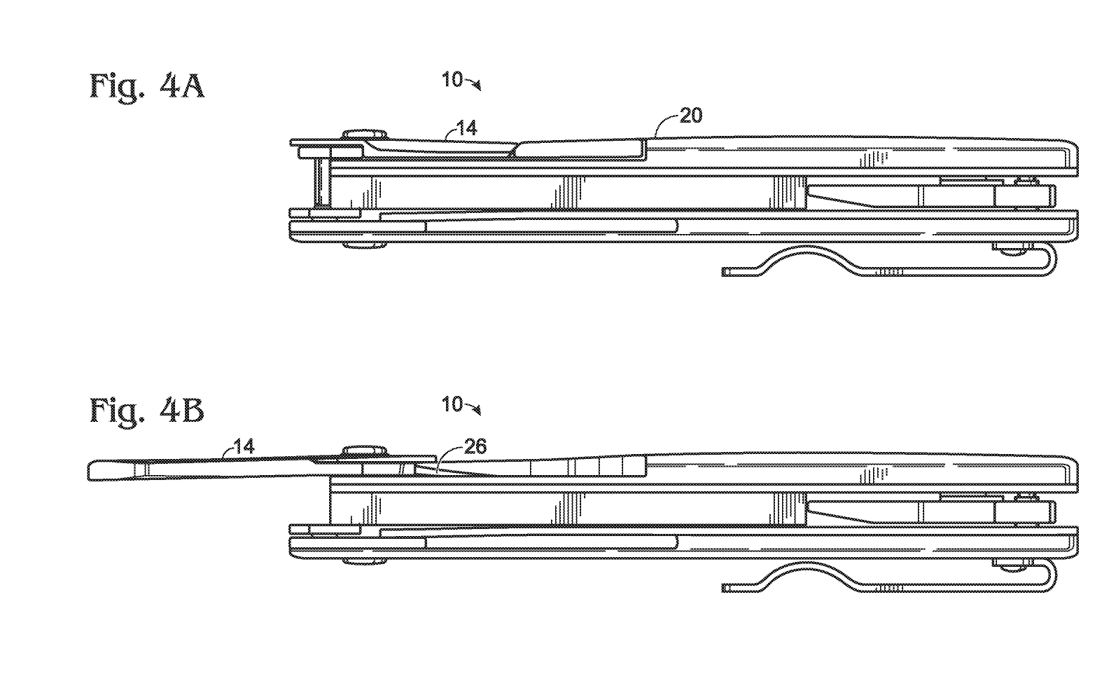

The handle assembly may be configured such that one or more of the tools is substantially flush with a gripping surface of the handle assembly when that tool is in the closed position. For example, as shown in FIG. 4A, the carabineer 14 is substantially flush with the gripping surface 20. As such, the carabineer is fully visible, even when in the closed position. In such a configuration, the carabineer pivots in the same plane as the gripping surface of the handle assembly. To accommodate the carabineer in the closed position, the handle assembly has a recessed portion 22.

In contrast to the carabineer, the blade and the tertiary tool are not flush with the gripping surface of the handle assembly. Instead, the blade is protected between opposing gripping surfaces, and the tertiary tool is positioned between a gripping surface and the blade.

In the illustrated embodiment, each of the primary, secondary, and tertiary tools can be selectively locked in the opened position by a liner lock 24, liner lock 26, and liner lock 28, respectively. In general, the handle assembly may include a liner lock that is biased towards a folding plane of a tool (e.g., a folding plane of the blade). When the tool is in the closed position, the tool prevents the liner lock from moving into the folding plane. When the tool is in the opened position, the liner lock is free to move into the folding plane. Using the secondary tool as an example, FIG. 4B shows the liner lock 26 moved into the folding plane and engaging a tang of the secondary tool such that the secondary tool cannot be pivoted to the closed position unless the liner lock 26 is manually moved out of the folding plane of the secondary tool. U.S. Pat. Nos. 6,145,202 and 6,397,476, which are hereby incorporated herein by reference for all purposes, describe a nonlimiting example of a liner lock. It is to be understood that different types of liner locks, other types of locks, or no locks at all, may be used without departing from the scope of this disclosure. Further, while the illustrated embodiment includes a lock for each of the primary, secondary, and tertiary tools, it is to be understood that one to all of the tools may be implemented without a lock.

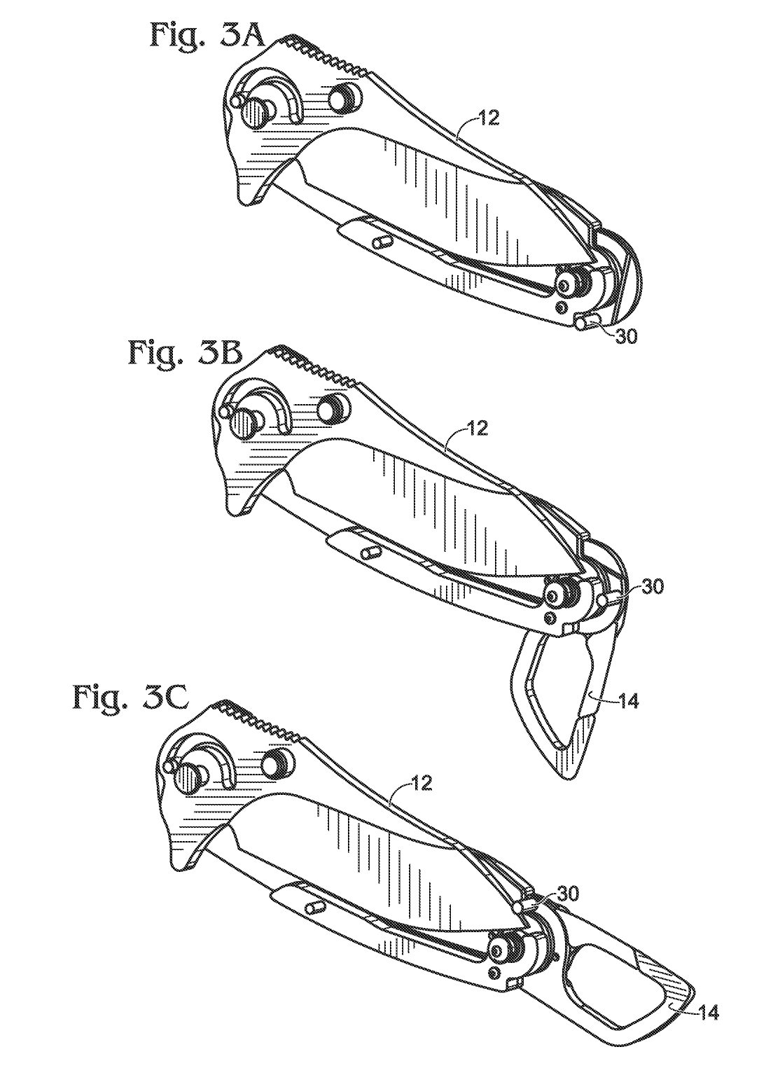

Additionally or alternatively, one or more locks may be used to lock a tool in the closed position. For example, as best shown in FIGS. 3A-3B, a secondary tool, such as the carabineer 14, may include a locking member 30 that traps a primary tool, such as the blade 12, in the closed position when the secondary tool is in the opened position. In the illustrated embodiment, the locking member 30 is a post that extends from a tang of the carabineer in a direction that is perpendicular to a folding plane of the carabineer.

In this way, both the primary tool and the secondary tool may be freely opened when both tools are in the closed position. However if the secondary tool is opened while the primary tool is closed, the secondary tool will effectively lock the primary tool in the closed position. For example, when the carabineer 14 is opened, the blade 12 is trapped closed by the post extending from the tang of the carabineer. Furthermore, because the carabineer may be locked open by a liner lock, the blade will remained trapped until a user deactivates the liner lock 26 and moves the carabineer to the closed position. Such a configuration prevents the blade from accidentally opening when the carabineer is deployed.

In some embodiments, bias elements may be used to assist the primary, secondary, and/or tertiary tools from an intermediate position to the opened position. A bias element also may be configured to resist pivoting the tool from the closed position to the intermediate position. As such, the bias element can help prevent the tool from accidentally opening, but can assist a user with the opening after the user initiates the opening procedure. U.S. Pat. Nos. 6,145,202 and 6,397,476, which are hereby incorporated herein by reference for all purposes, describe example bias elements.

It will be understood that the configurations and/or approaches described herein are exemplary in nature, and that these specific embodiments or examples are not to be considered in a limiting sense, because numerous variations are possible. The subject matter of the present disclosure includes all novel and nonobvious combinations and subcombinations of the various tool features disclosed herein, as well as any and all equivalents thereof.

1. A folding knife, comprising;
a handle assembly;
a blade pivotally connected to the handle assembly and configured to pivot from a closed position to an opened position; and
a secondary tool pivotally connected to the handle assembly and configured to pivot from a closed position to an opened position, the secondary tool including a locking member that traps the blade in the closed position when the secondary tool is in the opened position but allows the blade to pivot to the opened position when the secondary tool is in the closed position.

2. The folding knife of claim 1, where the locking member is a post extending from a tang of the secondary tool in a direction perpendicular to a plane of the secondary tool.

3. The folding knife of claim 1, where the secondary tool is a carabineer.

4. The folding knife of claim 1, where the handle assembly includes a gripping surface, and where the secondary tool is substantially flush with the gripping surface when the secondary tool is in the closed position.

5. The folding knife of claim 4, where the secondary tool is a carabineer.

6. The folding knife of claim 1, where the handle assembly includes a liner lock to lock the blade in the opened position.

7. The folding knife of claim 1, where the handle assembly includes a liner lock to lock the secondary tool in the opened position.

8. The folding knife of claim 7, where the secondary tool is a carabineer.

9. The folding knife of claim 1, further comprising a bias element configured to assist the blade in pivoting from an intermediate position, between the closed position and the opened position, to the opened position.

10. The folding knife of claim 1, further comprising a tertiary tool pivotally connected to the handle assembly and configured to pivot from a closed position to an opened position.

11. The folding knife of claim 10, where the handle assembly includes a gripping surface, and where the tertiary tool is between a plane of the gripping surface and a plane of the blade.

12. The folding knife of claim 10, where the blade is positioned between a plane of the secondary tool and a plane of the tertiary tool.

13. A folding tool assembly, comprising;
a handle assembly including a gripping surface; and
a carabineer pivotally connected to the handle assembly and configured to pivot from a closed position to an opened position, where the carabineer is substantially flush with the gripping surface when the carabineer is in the closed position.

14. The folding knife of claim 13, where the handle assembly includes a liner lock to lock the carabineer in the opened position.

15. A folding tool assembly, comprising;
a handle assembly;
a primary tool pivotally connected to the handle assembly and configured to pivot from a closed position to an opened position; and
a secondary tool pivotally connected to the handle assembly and configured to pivot from a closed position to an opened position, the secondary tool including a locking member that traps the primary tool in the closed position when the secondary tool is in the opened position but allows the primary tool to pivot to the opened position when the secondary tool is in the closed position.

16. The folding tool assembly of claim 15, where the locking member is a post extending from a tang of the secondary tool in a direction perpendicular to a plane of the secondary tool.

17. The folding tool assembly of claim 15, where the secondary tool is a carabineer.

18. The folding tool assembly of claim 15, where the handle assembly includes a gripping surface, and where the secondary tool is substantially flush with the gripping surface when the secondary tool is in the closed position.

19. The folding tool assembly of claim 15, where the handle assembly includes a liner lock to lock the secondary tool in the opened position.

20. The folding tool assembly of claim 15, where the primary tool is a blade.
